(19) United States
(12) Patent Application Publication
(10) Pub. No.: US 2006/0077559 A1
(43) Pub. Date: Apr. 13, 2006

(54) Optical actuator sleeve assembly

(75) Inventors: Roy Guynn, Blacksburg, VA (US); Donald A. Kenagy, Atlanta, GA (US); John Carberry, Talbott, TN (US)

Correspondence Address: PITTS AND BRITTIAN P C, P O BOX 51295, KNOXVILLE, TN, 37950-1295, US

(73) Assignee: Neptec Optical Solutions, Inc., Jefferson City, TN (US)

(21) Appl. No.: 11/218,802

(22) Filed: Sep. 2, 2005

Related U.S. Application Data
(60) Provisional application No. 60/607,333, filed on Sep. 3, 2004.

(51) Int. Cl. G02B 27/12

(52) U.S. Cl. 359/640

(57) ABSTRACT

An optical switch with at least one optical actuator having an actuator body and a preformed mirror guide sleeve molded into an integral unit, operating with a mirror guide made of the same material as the actuator body and the mirror guide sleeve. The mirror guide sleeve is formed from a fused silica tube with an inside surface have a fine finish and an inside diameter within closely controlled tolerances. The actuator body is formed around the mirror guide sleeve by injection molding fused silica powder and then firing the mirror guide sleeve and the powder to form an integrated assembly of the actuator body and the mirror guide sleeve. The optical elements forming the optical switch are aligned in six axes.

### CROSS-REFERENCE TO RELATED APPLICATIONS

This Application claims the benefit of U.S. Provisional Patent Application Ser. No. 60/607,333 filed on Sep. 3, 2004.

### STATEMENT REGARDING FEDERALLY SPONSORED RESEARCH OR DEVELOPMENT

Not Applicable

### BACKGROUND OF THE INVENTION

1. Field of Invention

This invention pertains to an optical actuator operable over a wide temperature range with little loss of positioning accuracy. More particularly, this invention pertains to an optical actuator having an actuator body and a preformed mirror guide sleeve molded into an integral unit, operating with a mirror guide made of the same material as the actuator body and the mirror guide sleeve.

2. Description of the Related Art

Most redundancy applications relate to using fiber optics and their attendant components under such reliability metrics as are used in the electrical domain. For instance, aboard ships and aircraft are multiple paths for copper based command and communication routes, controlled by redundant infrastructure through some sort of selective apparatus, for example, a switch. The same is true in the telecommunications infrastructure, where multiple routes are available and switches operate a resilient pathway agility to assure that if one line is cut, another route is engaged. Copper based systems, as well as fiber optic based systems, are subject to cuts and component failure that require immediate back up and repair. The lack of an optical switch capable of operating, for example, under extreme temperatures, −40° to +85° C. for telecommunications, −65° to +100° C. for aerospace and defense, has limited the use of fiber optics, or created super redundant systems to overcome the lack of pathway resilient agile redundancy.

In test and measurement, the need for switching structures such as N×N or 1×N switches, again capable of free space operation, and capable within free space operation of operating with exceptionally low wavelength and temperature dependent loss has limited many test, monitoring, and measurement system applications.

### BRIEF SUMMARY OF THE INVENTION

According to one embodiment of the present invention, an optical switch actuator body is provided. The actuator body includes a mirror guide sleeve and an outer shell formed around the sleeve. The mirror guide sleeve is formed from a drawn, hollow cylinder of amorphous fused silica. The pre-finished fused quartz sleeve for the mirror guide sleeve is built inexpensively from fused quartz tube stock with an N1 surface finish internally and a nominal inside diameter held to a few microns tolerance. The actuator body is injection molded around the mirror guide sleeve of fused silica powders. After firing, the actuator body and the mirror guide sleeve become an integral unit with the mirror guide fixed to the actuator body and having the same coefficient of thermal expansion as the mirror guide, thereby ensuring a low temperature-dependent loss. In one embodiment, the actuator body, the mirror guide sleeve, the mirror guide, and the switch body are formed of material having the same low coefficient of thermal expansion, for example, fused silica.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an exploded view of one embodiment of a 1×2 optical switch;

FIG. 2 is a perspective view of one embodiment of an actuator;

FIG. 3 is an exploded view of one embodiment of an actuator;

FIG. 4 is a perspective view of one embodiment of an actuator body;

FIG. 5 is a cross-section view of the embodiment of the actuator body shown in FIG. 4;

FIG. 6 is a chart showing the temperature response of one test configuration of a switch;

FIG. 7 is a chart showing the temperature response of another test configuration of a switch; and

FIG. 8 is a chart showing the temperature response of a switch with one embodiment of the actuator body.

### DETAILED DESCRIPTION OF THE INVENTION

An optical switch actuator body 200 for use with an optical actuator 112 is disclosed. There is a need for fiber optic switches 100 that launch light from one or more collimators 114 into free space, reflect the light from both fixed and moving mirrors 104, 204, with the mirrors 104, 204 capable of virtually total reflection at 45 degree angles, and capture the light into one or more collimators 114 from the free space. The parameters that affect such free space switches 100 include the sensitivity of the launching and receiving positioning of one fiber in relation to the other to determine the alignment accuracy required, and with respect to the alignment accuracy, the number of axes needed to align and control. Another parameter is, considering these axial alignments and tolerances, the amount of thermal expansion (coefficient of thermal expansion or CTE) that is allowable for the various components and adhesive. In pursuing these goals, it was expected that matching the coefficient of thermal expansion and controlling it to within tens of parts per million per degree Celsius would be adequate. As shown below, a great amount of work yielded unexpected results and insights, causing a conclusion that the coefficient of thermal expansion of the working elements in the system of about 1 ppm per degree Celsius or less resulted in switches 100 with low loss and high repeatability.

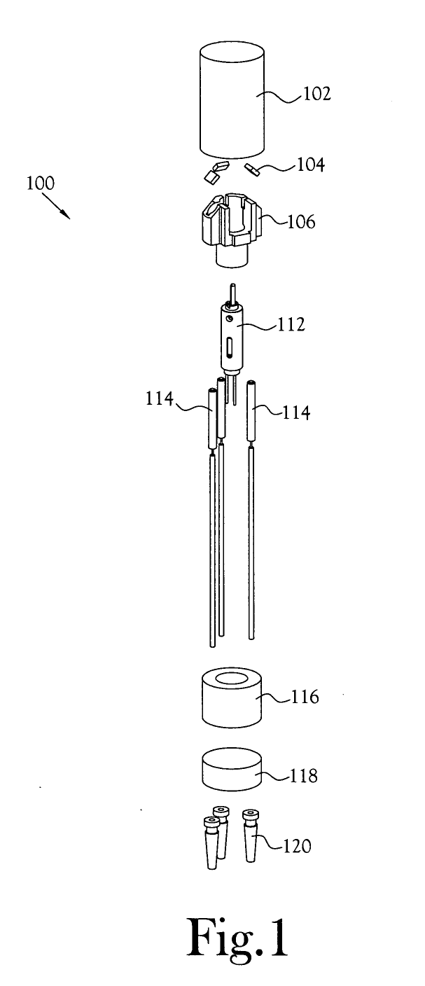

FIG. 1 illustrates an exploded view of one embodiment of a 1×2 optical switch 100. The complete switch 100 includes a switch body, or optical bench, 106 that holds an actuator 112, three mirrors 104, and three collimators 114 in an aligned configuration. The three mirrors 104 are positioned at a 45° angle relative to the optical signal path of their corresponding collimator 114. In an unswitched stated, an optical signal originates from one collimator 114 and is reflected by its corresponding mirror 104 into an opposite mirror 104 and finally into a corresponding collimator 114. With the actuator 112 operated, the optical signal is reflected by the actuator 112 into the third mirror 104 and into the third collimator 114. That is, the actuator 112 moves a mirror 204 into the light path and reflects it from one collimator 114 to a third collimator 114. In the actuated position, optical signal is reflected by three mirrors 104, 204 in the 1×2 switch 100. The precise alignment of the collimators 114, the mirrors 104, and the actuator 112 in relation to each other is crucial for minimizing any losses in the optical signal. The switch body 106, in conjunction with the adhesive securing the optical elements 104, 112, 114, are factors that affect the alignment of the optical elements 104, 112, 114.

Surrounding the switch body 106 is a case 102. The fiber end of the collimators 114 pass through a hydrophobic material 116 and a plug 118. The fiber end of each collimator 114 exits the switch 100 through a strain relief 120. The plug 118 seals the open end of the case 102 and the hydrophobic material 116 prevents moisture intrusion into the switch 100. Those skilled in the art will recognize that switch configurations other than a 1×2, such as a 1×N or N×N, can be constructed similarly without departing from the spirit and scope of the present invention.

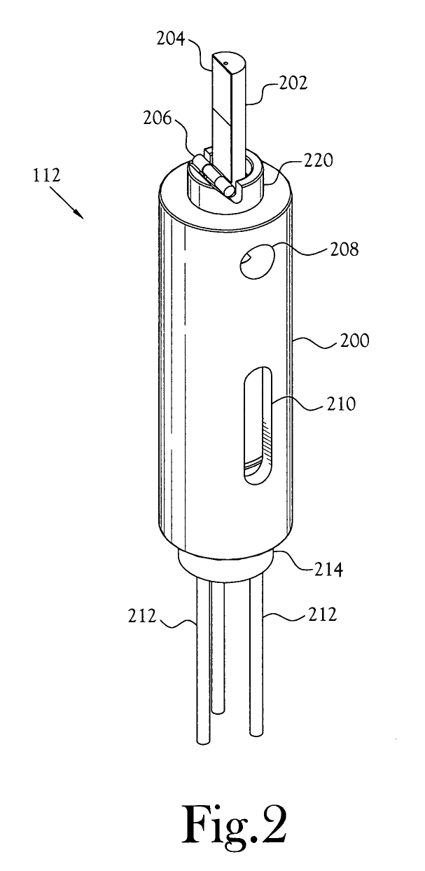

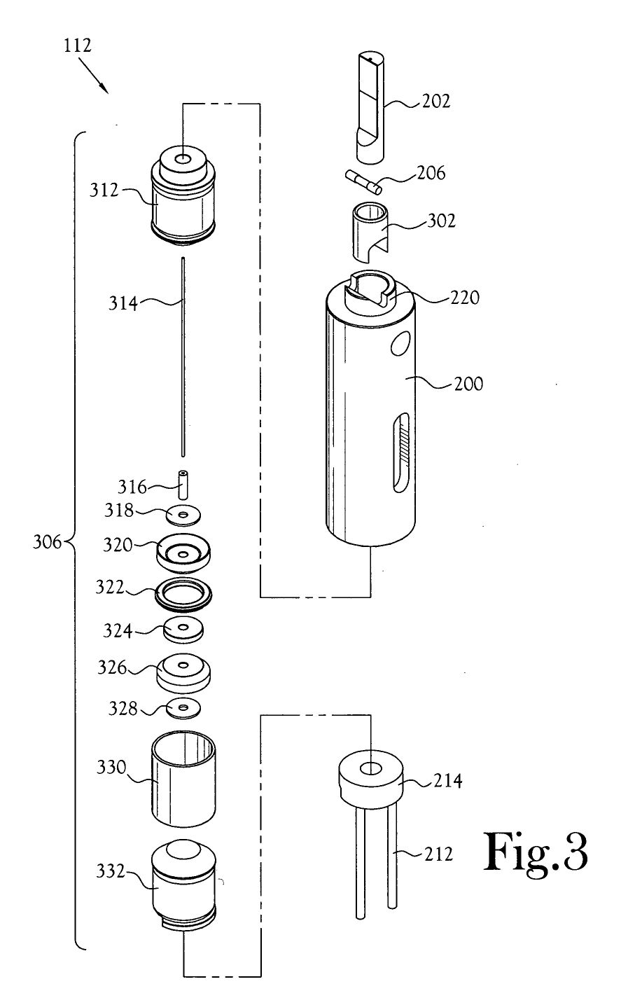

FIG. 2 illustrates a perspective view of one embodiment of an actuator 112. The actuator 112 has an actuator body 200 with a mirror guide 202 extending from one end. Extending from the opposite end is a flange 214 through which pass the electrical pins 212 to the drive mechanism 306 illustrated in FIG. 3. In the side of the actuator body 200 is a single adhesive slot 210 through which adhesive is introduced to secure the drive mechanism 306 to the actuator body 200. Also in the side of the actuator body 200 is a pair of observation and inspection ports 208.

The mirror guide 202 is made of fused silica in order to match its coefficient of thermal expansion with that of the other components it comes in contact with. By matching the coefficient of thermal expansion of the mirror guide 202 with that of the mirror guide sleeve 302 and the actuator body 200, exceptional temperature stability can be achieved resulting in low temperature-dependent losses (TDL). The lower end of the mirror guide 202 is surrounded by a sleeve support portion 220 of the actuator body 200. The mirror guide 202 is generally cylindrical with a flattened surface upon which a reflective coating is applied 204. This is the actuator mirror 204. The transition from the cylindrical outer surface of the mirror guide 202 to the flattened surface engages a stop cylinder 206. The position in which the mirror guide 202 engages the stop cylinder 206 defines the actuator's 200 extended position. The actuator's 200 retracted position is with the mirror guide 202 pulled inside the actuator body 200 a short distance.

FIG. 3 illustrates an exploded view of one embodiment of an actuator 112. The drive mechanism 306 extends from the bottom of the actuator body 200 and includes a pair of coils 312, 332 and a wire 314, a central plunger 316, a pair of spacers 318, 328, a pair of armatures 320, 326, a bearing 322, a magnet 324 enclosed in an internal sleeve 330. The electrical pins 212 are connected to the coils 312, 332, which, when energized, force the magnet 324 toward either the upper coil 312 or toward the lower coil 332. The central plunger 316 is connected to the pair of spacers 318, 328, the pair of armatures 320, 326, the bearing 322, and the magnet 324 such that the wire 314 moves in conjunction with the magnet 324.

The wire 314 passes through an opening in the center of the upper coil 312 and the end of the wire 314 opposite the central plunger 316 is connected to the mirror guide 202. Accordingly, the mirror guide 202 moves in conjunction with the magnet 324. The outward movement of the mirror guide 202 is limited by the stop cylinder 206. The mirror guide 202 slides within a mirror guide sleeve 302 which fits into the end of the actuator body 200. The upper end of the mirror guide sleeve 302 is surrounded by the sleeve support portion 220 of the actuator body 200.

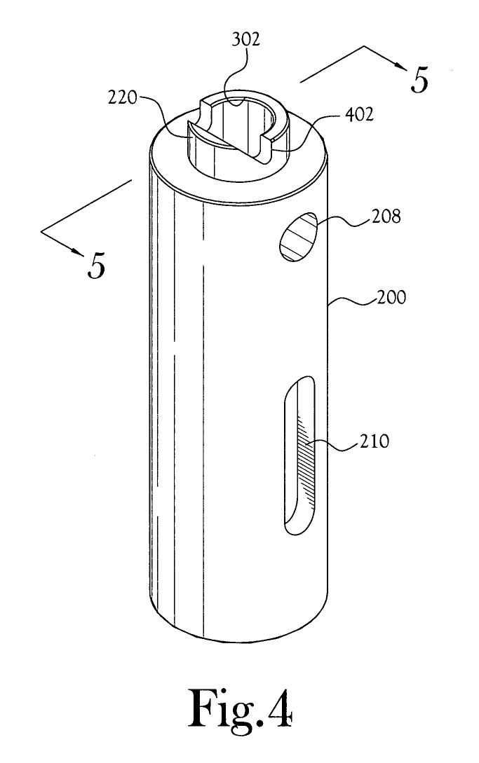

FIG. 4 illustrates a perspective view of one embodiment of an actuator body 200. The sleeve support portion 220 of the actuator body 200 includes a stop cylinder opening 402 for receiving the stop cylinder 206. The stop cylinder opening 402 is also formed in the mirror guide sleeve 302. The stop cylinder opening 402 has a vertical wall that is substantially parallel to the longitudinal axis of the actuator body 200. The opposite wall is sloped such that the stop cylinder 402 is wedged in the stop cylinder opening 402. The stop cylinder 206 is fixed in the stop cylinder 402 by an adhesive.

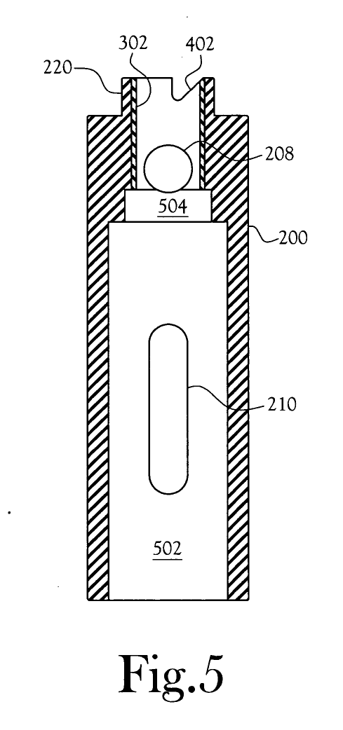

FIG. 5 illustrates a cross-section view of the embodiment of the actuator body 200 shown in FIG. 4. The actuator body 200 is a hollow cylinder. Inside the actuator body 200 is a central bore 502 that receives the major portion of the drive mechanism 306. At the inside end of the central bore 502 is a coil bore 504, which is a smaller diameter opening for receiving a portion of the core of the upper coil 312. The coil bore 504 abuts the mirror guide sleeve 302, which extends the rest of the way through the actuator body 200.

Shown in FIG. 5 is one of the two observation and inspection ports 208 that provide a view of the lower inside area of the mirror guide sleeve 302. These ports 208 are used to verify the clearance between the bottom of the mirror guide 202 and the top of the upper coil 312 when securing the wire 314 to the mirror guide 202. Also illustrated is the adhesive slot 210 through the sidewall of the central bore 502. The adhesive slot 210 allows the introduction of an adhesive for securing a portion of the drive mechanism 306 to the actuator body 200.

In one embodiment, the mirror guide sleeve 302 is formed from a drawn, hollow cylinder of amorphous fused silica and the actuator body 200 is formed of rebonded fused silica. The pre-finished fused quartz sleeve for the mirror guide sleeve 302 is built inexpensively from fused quartz tube stock with an N1 surface finish internally and a nominal inside diameter held to a few microns tolerance. An N1 finish is a finish defined by the ISO standard DIN ISO 1302, which requires an N1 finish to have a surface texture of no more than 0.025 microns (micrometers) which is the average measured value from the median line of a surface profile to its peak to valley. Those skilled in the art will recognize that other standards relating to surface textures may be used to identify the surface roughness. The actuator body 200 is injection molded around the mirror guide sleeve 302. The material used to injection mold the actuator body 200 is essentially pure fused silica powders. The resulting assembly of the actuator body 200 and mirror guide sleeve 302 is then fired, producing a single integrated component in which the inside of the mirror guide sleeve 302 has a precision surface and the actuator body 200 has bores 502, 504 for receiving components requiring less precision of assembly.

The steps required to produce the mirror guide sleeve 302 and actuator body 200 assembly include cutting and shaping a drawn, hollow cylinder of amorphous fused silica. The cutting and shaping includes cutting the mirror guide sleeve 302 to the desired length and forming a stop cylinder opening 402 in one end of the mirror guide sleeve 302. It also includes forming a pair of 20 observation and inspection ports 208 in the opposite end of the mirror guide sleeve 302. As part of the cutting and shaping step, the inside of the mirror guide sleeve 302 is given an N1 surface finish with an inside diameter maintained within a specified tolerance. The finish and dimensional tolerance of the inside of the mirror guide sleeve 302, in conjunction with the mirror guide 202, which has an outside surface equally finished and with good dimensional tolerance, ensures the accurate positioning of the mirror guide 202 and the long life of the actuator 200.

The next step is to injection mold around the cut and shaped mirror guide sleeve 302. This step involves positioning the mirror guide sleeve 302 in a mold and injecting fused silica powders into the mold. By ensuring the purity of the fused silica powders, the coefficient of thermal expansion of the rebonded fused silica is maintained as close as possible to that of pure fused silica. The mold is shaped to include the features in the actuator body 200 as described above with respect to FIG. 5. For example, the mold would include the pattern to form the central bore 502 and the coil bore 504, along with the inspection ports 208 and the adhesive slot 210. The central bore 502 and the coil bore 504 are suitable for forming with a mold because the drive mechanism 306 does not require the precision machined surfaces as does the inside surface of the mirror guide sleeve 302.

The next step is to fire the mirror guide sleeve 302 and the fused silica powders to form an actuator body 200 with an integral mirror guide sleeve 302. The complete assembly of the body 200 and integral sleeve 302 results in the assembly having the coefficient of thermal expansion as fused silica. Accordingly, there is no difference in the coefficient of thermal expansion of the mirror guide sleeve 302 and the actuator body 200, and there is no relative dimensional differences as the mirror guide sleeve 302 and the actuator body 200 experience widely varying temperature extremes.

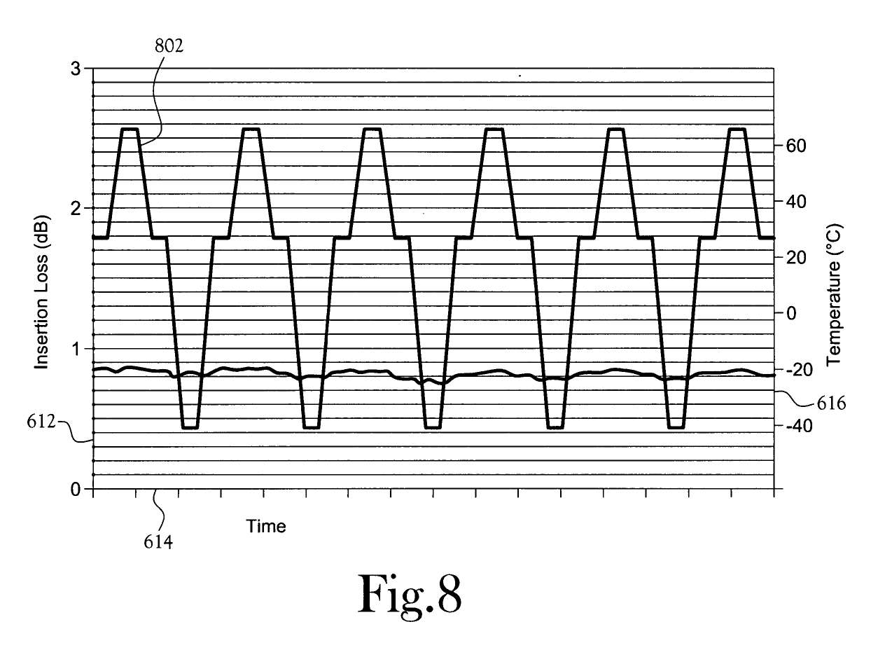

A switch 100 or other optical device having an actuator 112 with an actuator body 200 and mirror guide sleeve 302 fabricated as described has very low temperature-dependent losses compared to other fabrication methods that can be used. The chart in FIG. 8 illustrates the results obtained from testing a switch 100 made with an actuator 112 fabricated as described above.

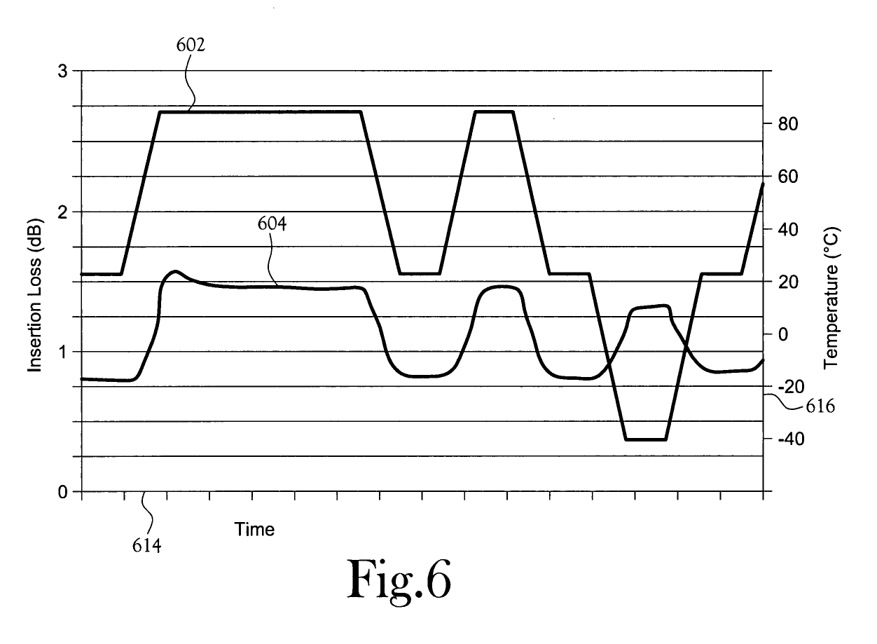

FIG. 6 illustrates a chart showing the temperature response of one test configuration of a switch 100. In the chart the temperature trace 602 is the controlled variable related to the right y-axis scale shown with units from −40° Celsius to +80° Celsius. The insertion loss test trace 604 is the measured variable related to the left y-axis scale shown with units from 0 dB to 3 dB insertion loss. The insertion loss shown is the temperature-dependent loss (TDL) because the temperature is the variable undergoing change over time. The x-axis of the graph is shown in units of time. Accordingly, the two traces 602, 604 reflect the change over time of the two variables of temperature and insertion loss through the test switch 100.

To demonstrate the sensitivity of optical devices to the requirement for matched low thermal expansion materials, a test switch 100 was fabricated with the mirror guide 202 made of zirconia with other items made of rebonded fused silica. Rebonded fused silica has a coefficient of thermal expansion of 0.53 ppm per degree Celsius, whereas zirconia has a coefficient of thermal expansion of 10 ppm per degree Celsius. The insertion loss test trace 604 illustrates a repeatable, regular temperature dependent loss. The switch 200 acts as a thermometer as can be seen from the correlation of the temperature trace 602 and the insertion loss test trace 604.

The optical mechanical path for the zirconia used in this test system is only a few hundred microns, from the 135° angle plane/pin contact point to the vertical plane of the mirror surface 204. In this test case, the excess TDL is clearly coming from the coefficient of thermal expansion of the zirconia as it is imparted to the pitch, roll, and yaw precision and accuracy of the mirror surface 204 as the temperature varies. The TDL shown on the chart is approximately 0.5 dB. This amount of TDL is not within specifications.

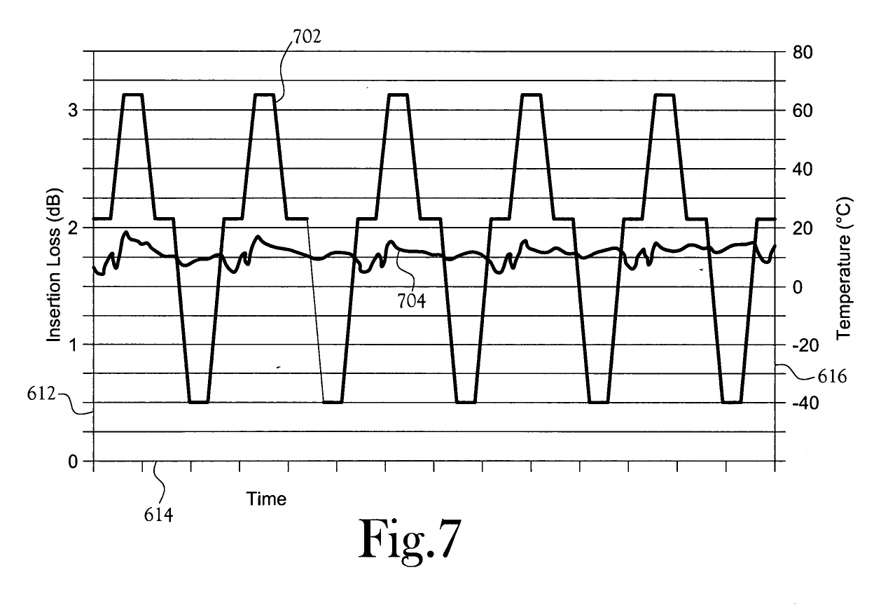

FIG. 7 illustrates a chart showing the temperature response of another test configuration of a switch 100. The test switch 100 producing the results illustrated in FIG. 7 was fabricated with fused silica for the mirror guide 202 and zirconia was substituted for fused silica in the sleeve 302 in which the mirror guide shuttle 202 slides up and down.

In the chart the temperature trace 702 is the controlled variable related to the right y-axis scale shown with units from −40° Celsius to +80° Celsius. The insertion loss test trace 704 is the measured variable related to the left y-axis scale shown with units from 0 dB to 3 dB insertion loss. The chart of FIG. 7 illustrates a very repeatable and regular temperature dependent loss, this time with patterns which at first seem difficult to understand until one sees that the sleeve 302 is mostly imparting its coefficient of thermal expansion through changes in axial alignment as pitch, roll, and yaw, and probably very little on x, y, or z. In this case the TDL shown on the chart for this test switch 100 is about 0.25 dB.

FIG. 8 illustrates a chart showing the temperature response of a switch 100 with one embodiment of the actuator body 200. The test switch 100 producing the results illustrated in FIG. 8 was fabricated with a fused silica mirror guide sleeve 302 and the actuator body 200 and the mirror guide 202 fabricated of rebonded fused silica. With the actuator body 200 constructed as illustrated in FIG. 5, the TDL shown on the chart for this test switch 100 is about 0.05 dB. The results of the test illustrated in FIG. 8 were not predictable. It is challenging at this level of repeatability and constancy, where light is launched and captured in free space between two collimators 114, reflecting off the surfaces of three mirrors 104, 204, and thermally cycling through large temperature ranges, to determine where the total 1.1% variability can be originating. One is not quite able to separate any variability in the measuring system from the object measured.

In achieving the results illustrated in FIG. 8 and addressing the goals of low loss and high repeatability of an optical switch 100, a true six-axis alignment tool capable of controlling all six axis within tens of nanometers was used. The alignment tool controlled all six axes by a feedback algorithm capable of finding very low level light, approximately −50 dB, and peaking light, to within a few hundredths of a dB of theoretical alignment. The six axes include the x, y, z axes and pitch, roll, and yaw.

With respect to the collimators 114, roll was determined to be an axis needing control because collimators 114 have a pointing angle, and that pointing angle has both a position on the compass and a magnitude of angle along that position. After tuning the pitch and yaw for a collimator 114, any change in roll, such as a temperature-dependent change, affected the amount of signal loss. Further, the z-axis alignment has a great affect on the amount of losses because after aligning pitch, roll and yaw, it was found that the perfect alignment along the pitch, roll and yaw axis was only achieved at one point along the z-axis. Moving away from the aligned point on the z-axis moved that point and affected the amount of signal loss. The lateral alignments along the x- and y-axes is also sensitive to an optimal alignment, and, furthermore, the coincidental pointing angles of the collimator pairs 114 needs the x- and y-axes to be controlled.

After exploring the limits of the precise and accurate alignments of the various major optical elements 112, 114, 104, it was discovered that in order to maintain a very low temperature-dependent loss over a wide temperature range a surprisingly low coefficient of thermal expansion for certain elements was required. The desired temperature dependent loss is 0.1 dB between a lower temperature of −40° to −65° and an upper temperature of +85° to +100° Celsius.

In order to achieve the desired low losses and repeatability, it was determined that the switch 100 had to be built upon an optical bench (switch body 106) that is stiff and has a coefficient of thermal expansion typically less than 1 part per million, for example, about 0.5 ppm. The components making up the switch 100, for example the collimators 114 and the actuator 112, have to be aligned along six axes simultaneously, for example, aligned with a six-axis alignment toll that can control all six axes simultaneously to find and hold the peak alignment in six-axis space.

Further, an adhesive must join the various components to the optical bench, or switch body, 106 after the precise and accurate six-axis alignment has been accomplished. The adhesive must be capable of quickly curing, for example, in less than five minutes, have low shrinkage, for example, less than 0.1%, and have a low coefficient of thermal expansion, for example, less than 10 ppm. Also, there are advantages to applying the adhesive to certain elements by using opposing slots or openings.

The mirror guide 202 of the actuator 112 and the sleeve 302 in which the mirror guide 202 slides must be built within very, very close tolerances, from these same very low coefficient of thermal expansion materials as used in other parts of the switch 100. An example of the tolerance is that the inside diameter of the mirror guide sleeve 302 and the outside diameter of the mirror guide 202 must be controlled within several microns. The mirror guide sleeve 302 is made from a pre-finished fused quartz sleeve, which can be built inexpensively from fused quartz tube stock formed into a cylinder with an N1 surface finish internally and a nominal ID held to a few microns tolerance. The actuator body 200 is injection molded with essentially pure fused silica powders into precision shapes around the mirror guide sleeve 302 and is then fired to fuse the actuator body 200 to the mirror guide sleeve 302 to form a unitary assembly with a coefficient of thermal expansion of 0.53 ppm. This fabrication procedure allows the mirror guide sleeve 302 to have the surface finish and tolerances required to achieve a low temperature-dependent loss.

The actuator body 200 includes various functions. The function of driving the mirror guide 202 is implemented, in one embodiment, by the drive mechanism 306 connected to the mirror guide 202 by the wire 314.

From the foregoing description, it will be recognized by those skilled in the art that an optical switch 100 with low sensitivity to temperature has been provided. The optical switch 100 includes one or more actuators 112 that include a mirror guide 202 that moves along the z-axis inside a mirror guide sleeve 302 fixed to an actuator body 200. The mirror guide sleeve 302 is formed from a fused silica tube with an inside surface have a fine finish and an inside diameter within closely controlled tolerances. The actuator body 200 is formed around the mirror guide sleeve 302 by injection molding fused silica powder and then firing the mirror guide sleeve 302 and the powder to form an integrated assembly of the actuator body 200 and the mirror guide sleeve 302. With the mirror guide 202, the mirror guide sleeve 302, and the actuator body 200 formed from fused silica and with a fine finish and close tolerances between the mirror guide 202 and the mirror guide sleeve 302, the temperature-dependent losses associated with the actuator 112 are minimized.

Further, the sensitivity of the optical switch 100 to alignment error at assembly or through thermal cycling is intolerably sensitive with regard to the six-axis alignment accuracy. Such sensitivity can be reduced by structuring the switch 100 using materials with stiff, low coefficient of thermal expansion and adhesives with exceptionally low shrinkage and low coefficient of thermal expansion in slots diametrically opposed to each other and following the z axis and by using alignment tools capable of driving six-axis alignments through interactive routines capable of finding theoretical set points in alignment of all six axis.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for controlling an optical signal, said apparatus comprising:
a mirror guide having a cylindrical base, said cylindrical base having a diameter that varies within a first specified tolerance, said cylindrical base having a cylindrical surface with a first specified surface texture, said mirror guide formed of a material having a selected coefficient of thermal expansion;
a mirror guide sleeve having an inside diameter that varies within a second specified tolerance, said mirror guide sleeve formed of a material having a coefficient of thermal expansion substantially the same as said selected coefficient of thermal expansion of said mirror guide, said mirror guide sleeve receiving said cylindrical base of said mirror guide, said mirror guide having an inside surface with a second specified surface texture,
an actuator body fused to said mirror guide sleeve, said actuator body having a longitudinal axis coaxial to a longitudinal axis of said mirror guide sleeve, said actuator body formed of a material having a coefficient of thermal expansion substantially the same as said selected coefficient of thermal expansion of said mirror guide; and
a means for driving said mirror guide between an extended position and a retracted position by causing said mirror guide to move axially in said mirror guide sleeve.

2. The apparatus of claim 1 further including a switch body having a first collimator optically connected with a second collimator, said mirror guide optically connecting said first collimator with a third collimator when said mirror guide is in said extended position.

3. The apparatus of claim 2 wherein said switch body further includes a first mirror adjacent said first collimator, a second mirror adjacent said second collimator, and a third mirror adjacent said third collimator whereby said first and second mirrors are in optical communication with said first and second collimators and said first and third mirrors are in optical communication with said first and third collimators when said mirror guide is in said extended position.

4. The apparatus of claim 2 wherein an optical connection between said first and third collimators has no more than 0.1 dB of temperature-dependent loss over a temperature range of −40 degrees to +80 degrees Celsius.

5. The apparatus of claim 1 wherein said mirror guide includes a reflective surface.

6. The apparatus of claim 1 wherein said material of said mirror guide is fused silica.

7. The apparatus of claim 1 wherein said material of said actuator body is rebonded fused silica.

8. The apparatus of claim 1 wherein said selected coefficient of thermal expansion is less than or equal to 1 part per million per degree Celsius over a temperature range of −40 degrees to +80 degrees Celsius.

9. The apparatus of claim 1 further including a stop cylinder fixed to at least one of said mirror guide sleeve and said actuator body, said stop cylinder engaging said mirror guide when said mirror guide is in said extended position.

10. An apparatus for controlling an optical signal, said apparatus comprising:
a mirror guide having a cylindrical base;
a mirror guide sleeve receiving said cylindrical base of said mirror guide,
said mirror guide sleeve formed of a material having a coefficient of thermal expansion substantially the same as said selected coefficient of thermal expansion of said mirror guide;
an actuator body fused to said mirror guide sleeve, said actuator body formed of a material having a coefficient of thermal expansion substantially the same as said selected coefficient of thermal expansion of said mirror guide;
a stop cylinder fixed to at least one of said mirror guide sleeve and said actuator body, said stop cylinder engaging said mirror guide when said mirror guide is in an extended position; and
a means for driving said mirror guide between said extended position and a retracted position by causing said mirror guide to move axially in said mirror guide sleeve.

11. The apparatus of claim 10 wherein said cylindrical base of said mirror guide has a diameter that varies within a first specified tolerance, and said cylindrical base has a cylindrical surface with a first specified surface texture.

12. The apparatus of claim 10 wherein said mirror guide sleeve has an inside diameter that varies within a second specified tolerance, and said mirror guide has an inside surface with a second specified surface texture.

13. The apparatus of claim 10 further including a switch body having a first collimator optically connected with a second collimator, said mirror guide optically connecting said first collimator with a third collimator when said mirror guide is in said extended position.

14. The apparatus of claim 13 wherein said switch body further includes a first mirror adjacent said first collimator, a second mirror adjacent said second collimator, and a third mirror adjacent said third collimator whereby said first and second mirrors are in optical communication with said first and second collimators and said first and third mirrors are in optical communication with said first and third collimators when said mirror guide is in said extended position.

15. The apparatus of claim 10 wherein said material of said mirror guide is fused silica, and said material of said actuator body is rebonded fused silica.

16. The apparatus of claim 10 wherein said material of said mirror guide sleeve is fused silica, and said material of said actuator body is rebonded fused silica.

17. The apparatus of claim 10 wherein said selected coefficient of thermal expansion is less than or equal to 1 part per million per degree Celsius over a temperature range of −40 degrees to +80 degrees Celsius.

18. A method for fabricating an optical device, said method comprising the steps of:
a) cut and shape a mirror guide sleeve, said mirror guide sleeve having an inside surface with a specified surface texture, said mirror guide sleeve having an inside diameter that varies within a first specified tolerance, said mirror guide formed of fused silica;
b) after said step of cut and shape said mirror guide sleeve, mold an actuator body around said mirror guide sleeve;
c) after said step of molding, fire said actuator body and said mirror guide sleeve to form an integrated, fused assembly;
d) after said step of firing, insert a drive mechanism into a cavity in said actuator body;
e) after said step of firing, insert a mirror guide into said mirror guide sleeve; and
f) operatively connect said drive mechanism to said mirror guide whereby said mirror guide is adapted to move along an axis of said mirror guide sleeve by said drive mechanism.

19. The method of claim 18 further including the steps of:
g) insert said actuator body into an optical bench;
h) insert a plurality of collimators in said optical bench;
i) align said actuator body and said plurality of collimators in six axes; and
j) fix said actuator body and said plurality of collimators to said optical bench with an adhesive whereby said actuator body and said plurality of collimators maintain an alignment.

20. The method of claim 19 wherein said step j) of fixing said actuator body includes the step of applying an adhesive to a pair of opposing slots whereby said adhesive contacts said optical bench and said actuator body, and the step of applying an adhesive to a pair of opposing slots whereby said adhesive contacts said optical bench and one of said plurality of collimators.
